(19) United States
(12) Patent Application Publication
(10) Pub. No.: US 2026/0236757 A1
(43) Pub. Date: Aug. 13, 2026

(54) DEVICE AND METHOD WITH CONTROL OF NEURAL NETWORK BIT PRECISION

(71) Applicants: Samsung Electronics Co., Ltd., Suwon-si (KR); UIF (University Industry Foundation), Yonsei University, Seoul (KR)

(72) Inventors: Yuseok JEONG, Hwaseong-si (KR); Hanjun KIM, Suwon-si (KR); Haeeun JEONG, Seoul (KR); Jaeho LEE, Seoul (KR); Heelim CHOI, Seoul (KR); Ju Min LEE, Seoul (KR); Hyunho KWON, Seoul (KR); Moongyung KIM, Suwon-si (KR); Seonghoo KIM, Hwaseong-si (KR); Hyunpil KIM, Seoul (KR); Sanghwan PARK, Anyang-si (KR); DeokHyun AHN, Hwaseong-si (KR); Soobok YEO, Suwon-si (KR); Do-Young LEE, Suwon-si (KR); Mingu JEONG, Suwon-si (KR); JongMin JEONG, Suwon-si (KR); Taedong JUNG, Seoul (KR)

(73) Assignees: Samsung Electronics Co., Ltd., Suwon-si (KR); UIF (University Industry Foundation), Yonsei University, Seoul (KR)

(21) Appl. No.: 19/302,868

(22) Filed: Aug. 18, 2025

(30) Foreign Application Priority Data
Feb. 10, 2025 (KR) 10-2025-0016828

(51) Int. Cl. G06N 3/063

(52) U.S. Cl. CPC G06N 3/063

(57) ABSTRACT

A method of operating an electronic device includes: inputting input data to a neural network (NN) model including layers; determining compression information indicating a compressed degree of a bit width of weights and input values of a target layer, wherein the target layer is a layer among the layers in which an operation is to be performed; compressing the weights and the input values to the bit width based on the compression information; packing the compressed weights and the compressed input values into a vector register; performing an operation between the compressed weights and the compressed input values packed into the vector register; and generating output data of the NN model according to an input of the input data based on a result of the operation between the compressed weights and the compressed input values.

### CROSS-REFERENCE TO RELATED APPLICATIONS

This application claims the benefit under 35 USC § 119(a) of Korean Patent Application No. 10-2025-0016828, filed on Feb. 10, 2025, in the Korean Intellectual Property Office, the entire disclosure of which is incorporated herein by reference for all purposes.

### BACKGROUND

### 1. Field

The following description relates to a method and device with control of neural network bit precision.

### 2. Description of Related Art

A deep neural network (DNN) is a type of artificial neural network and may have a structure that includes hidden layers. DNNs are a core component of deep learning, which learns patterns and representations from data and may solve various complex problems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of operating an electronic device includes: inputting input data to a neural network (NN) model including layers; determining compression information indicating a compressed degree of a bit width of weights and input values of a target layer, wherein the target layer is a layer among the layers in which an operation is to be performed; compressing the weights and the input values to the bit width based on the compression information; packing the compressed weights and the compressed input values into a vector register; performing an operation between the compressed weights and the compressed input values packed into the vector register; and generating output data of the NN model according to an input of the input data based on a result of the operation between the compressed weights and the compressed input values.

The determining of the compression information may include determining the compression information by identifying a data format of the weights and the input values and determining whether the weights and the input values are compressible by a method based on the data format.

The determining of the compression information may include: in response to a data format of the weights or the input values being determined to be an integer format, determining whether a compressible pattern exists at the most significant bit of the weights or the input values; and in response to the compressible pattern existing, determining the compression information based on the compressible pattern.

The determining of the compression information may include: in response to a data format of the weights or the input values being determined to be a fixed point format, determining whether a compressible pattern exists for each of an integer part and a fractional part of the weights or the input values; and in response to the compressible pattern existing in at least one of the integer part or the fractional part, determining the compression information based on the compressible pattern existing in at least one of the integer part or the fractional part.

The determining of whether the compressible pattern exists may include determining whether the compressible pattern exists based on a most significant bit of the integer part, and determining whether the compressible pattern exists based on a least significant bit of the fractional part.

The determining of the compression information may include: in response to a data format of the weights or the input values being determined to be a floating point format, determining whether the compressible pattern exists for each of an exponent part and a mantissa part of the weights or the input values; in response to the compressible pattern existing in each of the exponent part and the mantissa part, determining whether each of the exponent part and the mantissa part is compressible enough to satisfy a predefined bit number; and in response to each of the exponent part and the mantissa part being compressible enough to satisfy the predefined bit number, determining the compression information based on the compressible pattern.

The compressing of the weights and the input values to the bit width may include: in response to a data format of the weights being determined to be an integer format or a fixed point format, determining a lowest bit precision based on the compression information, and compressing the weights to have the lowest bit precision.

The compressing of the weights and the input values to the bit width may include: in response to a data format of the weights or the input values being determined to be a floating point format, determining a format that uses a least bit width from the floating point format based on the compression information, and compressing the weights or the input values into a format that uses the least bit width.

The packing of the compressed weights and the compressed input values into the vector register may include, in response to a bit width of the compressed weights or a bit width of the compressed input values being different from a bit width supported by the vector register, restoring the compressed weights or the compressed input values to the bit width supported by the vector register.

The method may further include: determining a ratio of sampling some weights of the weights of the target layer until a ratio of decreasing inference accuracy of the NN model reaches a threshold ratio; and determining the compression information for compressing the some weights to a degree higher than a compressible degree until the ratio reaches the threshold ratio.

In another general aspect, a non-transitory computer-readable storage medium stores one or more programs, and the one or more programs include code that when executed cause operations of: inputting input data to a neural network (NN) model including layers; determining compression information indicating a compressed degree of a bit width of weights and input values of a target layer, wherein the target layer is a layer among the layers in which an operation is to be performed; compressing the weights and the input values to a bit width based on the compression information; packing the compressed weights and the compressed input values into a vector register; performing an operation between the compressed weights and the compressed input values packed into the vector register; and generating output data of the NN model according to an input of the input data based on a result of the operation between the compressed weights and the compressed input values.

In another general aspect, an electronic device includes: one or more processors; and; a memory storing instructions that when executed by the one or more processors cause the electronic device to: input input data to a neural network (NN) model including layers; determine compression information indicating a compressed degree of a bit width of weights and input values of a target layer, wherein the target layer is a layer among the layers in which an operation is to be performed; compress the weights and the input values to the bit width based on the compression information; pack the compressed weights and the compressed input values into a vector register; perform an operation between the compressed weights and the compressed input values packed into the vector register; and generate output data of the NN model according to an input of the input data based on a result of the operation between the compressed weights and the compressed input values.

The instructions, when executed by the one or more processors, may cause the electronic device to determine the compression information by identifying a data format of the weights and the input values and determining whether the weights and the input values are compressible by a method based on the data format.

The instructions, when executed by the one or more processors, may cause the electronic device to: in response to a data format of the weights or the input values being determined to be an integer format, determine whether a compressible pattern exists based on a most significant bit of the weights or the input values; and in response to the compressible pattern existing, determine the compression information based on the compressible pattern.

The instructions, when executed by the one or more processors, may cause the electronic device to: in response to a data format of the weights or the input values being determined to be a fixed point format, determine whether a compressible pattern exists for each of an integer part and a fractional part of the weights or the input values; and in response to the compressible pattern existing in at least one of the integer part or the fractional part, determine the compression information based on the compressible pattern existing in at least one of the integer part or the fractional part.

The instructions, when executed by the one or more processors, may cause the electronic device to determine whether the compressible pattern exists at a most significant bit of the integer part, and determine whether the compressible pattern exists at the least significant bit of the fractional part.

The instructions, when executed by the one or more processors, may cause the electronic device to: in response to a data format of the weights or the input values being determined to be a floating point format, determine whether the compressible pattern exists for each of an exponent part and a mantissa part of the weights or the input values; in response to the compressible pattern existing in each of the exponent part and the mantissa part, determine whether each of the exponent part and the mantissa part is compressible enough to satisfy a predefined bit number; and in response to each of the exponent part and the mantissa part being compressible enough to satisfy the predefined bit number, determine the compression information based on the compressible pattern.

The instructions, when executed by the one or more processors, may cause the electronic device to: in response to a data format of the weights being determined to be an integer format or a fixed point format, determine a lowest bit precision based on the compression information, and compress the weights to have the lowest bit precision.

The instructions, when executed by the one or more processors, may cause the electronic device to: in response to a data format of the weights or the input values being determined to be a floating point format, determine a format that uses a least bit width from the floating point format based on the compression information, and compress the weights or the input values into a format that uses the least bit width.

The instructions, when executed by the one or more processors, may cause the electronic device to: in response to a bit width of the compressed weights or a bit width of the compressed input values being different from a bit width supported by the vector register, restore the bit width of the compressed weights or the bit width of the compressed input values to the bit width supported by the vector register.

Other features and aspects will be apparent from the following detailed description, the drawings, and the claims.

### BRIEF DESCRIPTION OF THE DRAWINGS

FIG. 1 illustrates an example of an electronic device, according to one or more embodiments.

FIG. 2 illustrates an example of a deep neural network (DNN) model, according to one or more embodiments.

FIG. 3 illustrates an example of representation formats of real numbers, according to one or more embodiments.

FIG. 4 illustrates an example of an operation of an electronic device for determining compression information, according to one or more embodiments.

FIG. 5 illustrates an example of an operation of an electronic device for verifying the length of a vector register and presence of hardware performing compression, according to one or more embodiments.

FIGS. 6 and 7 illustrate examples of an operation of an electronic device for performing compression and packing, according to one or more embodiments.

FIGS. 8 and 9 illustrate examples of a compressible pattern in a floating point format, according to one or more embodiments.

FIG. 10 illustrates an example of a method of increasing a degree of compression, according to one or more embodiments.

FIG. 11 illustrates an example of an operation of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

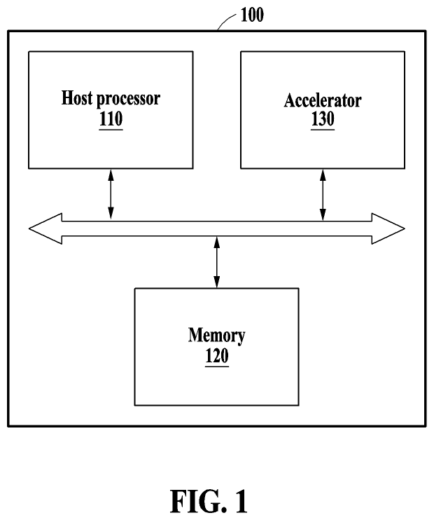

FIG. 1 illustrates an example of an electronic device, according to one or more embodiments.

Referring to FIG. 1, an electronic device 100 may include a host processor 110, a memory 120, and an accelerator 130. The host processor 110, the memory 120, and the accelerator 130 may communicate with one another through a bus, a network on a chip (NoC), or a peripheral component interconnect express (PCIe). In the example of FIG. 1, only components related to examples described herein are illustrated in the electronic device 100. Thus, it is obvious to one of ordinary skill in the art that the electronic device 100 may further include other general-purpose components in addition to the components illustrated in FIG. 1.

The host processor 110 may perform overall functions for controlling the electronic device 100. The host processor 110 may generally control the electronic device 100 by executing programs and/or instructions stored in the memory 120. The host processor 110 may be implemented as a central processing unit (CPU), a graphics processing unit (GPU), or an application processor (AP), which is included in the electronic device 100, but examples are not limited thereto.

The memory 120 may be hardware for storing data processed in the electronic device 100 and data to be processed. In addition, the memory 120 may store an application, a driver, and the like to be driven by the electronic device 100. The memory 120 may include volatile memory, such as dynamic random-access memory (DRAM), and/or non-volatile memory.

The electronic device 100 may include the accelerator 130 for an operation. The accelerator 130 may process tasks that may be more efficiently processed by a separate exclusive processor (that is, the accelerator 130), rather than by the general-purpose host processor 110, due to characteristics of the tasks. For example, a large language model (LLM) may be executed on the accelerator 130. Here, one or more processing elements (PEs) included in the accelerator 130 may be utilized. The accelerator 130 may correspond to, for example, a neural processing unit (NPU), a tensor processing unit (TPU), a digital signal processor (DSP), a GPU, or a neural engine, which performs an operation according to a neural network. It is apparent to those skilled in the art that tasks that are more efficiently processed by the accelerator 130 may not necessarily be processed by the accelerator 130 but may be processed by the host processor 110.

According to an example, the operations of the electronic device 100 to be described in the present disclosure that may be performed when performing inference using a deep neural network (DNN) model may be implemented in terms of software or hardware. For example, when implemented in terms of software, instructions stored in the memory 120 may be individually and/or collectively executed by at least one processor, and the instructions may cause the electronic device 100 to perform the operations of the present disclosure. The at least one processor may include the host processor 110 and/or the accelerator 130. For example, when implemented in terms of hardware, the operations described in the present disclosure may be performed by hardware devices, and the hardware devices may be included in the accelerator 130. For example, when the accelerator 130 is included in the host processor 110 in a coprocessor format, the hardware devices may be included in the host processor 110.

Hereinafter, a NN model will be described.

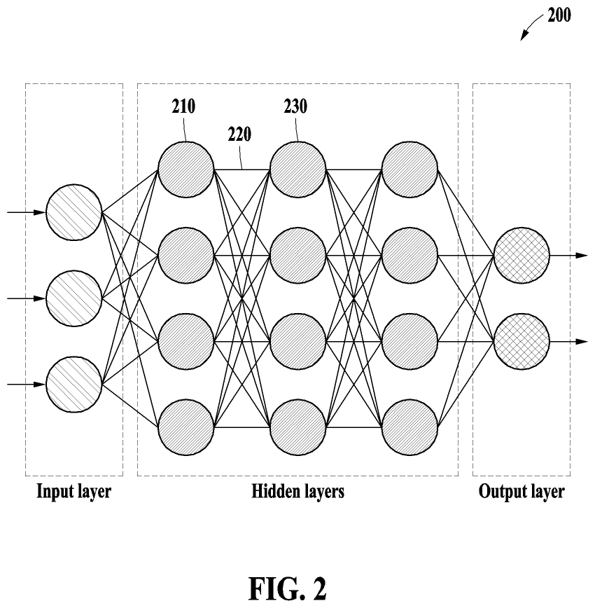

FIG. 2 illustrates an example of a NN model, according to one or more embodiments.

Referring to FIG. 2, an example of a NN model 200 including three hidden layers is illustrated. The NN model is a type of artificial neural network and may have a structure that includes a plurality of hidden layers. The NN is a core component of deep learning, which automatically learns patterns and representations from data and may solve various complex problems.

The NN model 200 may include an input layer, a plurality of hidden layers, and an output layer.

The input layer may be a first layer that transmits input data to the NN model. The input layer itself does not have weights or biases, and may transmit input data to hidden layers.

The hidden layer may perform an operation on the input data transmitted from the input layer. The NN model 200 may include two or more hidden layers. The hidden layers may be connected to each other. Herein, for convenience of description, a hidden layer may be referred to as a layer.

It is assumed that the first hidden layer and the second hidden layer are connected through a plurality of synapses in series. An output value of the first hidden layer may be an input value of the second hidden layer. The output value of the first hidden layer (e.g., the input value of the second hidden layer) may be multiplied by a weight of the second hidden layer and transmitted to the second hidden layer. The weight may represent the connection strength between neurons.

For example, a neuron 210 of the first hidden layer may be connected to a neuron 230 of the second hidden layer via a synapse 220. The connection strength between neuron 210 and the neuron 230 may be represented by a weight of the synapse 220. The input value of the neuron 230 (e.g., the output value of the neuron 210) may be multiplied by the weight of the synapse 220. Herein, for convenience of description, a layer, in which an operation is to be performed, among the plurality of layers may be referred to as a target layer.

Various formats may be used to represent the input values and weights of the hidden layers. For example, an integer format, a fixed point format, or a floating point format may be used to represent the input values and the weights. According to an example, each of the layers within the NN model 200 may include weights represented in a format different from other layers, and may receive input values represented in the different format.

The output layer is the last layer that outputs a final result and may output an inference result of the NN model 200. The output of intermediate layers (e.g., hidden layers) other than the output of the last layer may be referred to as intermediate values. For example, the output value of the first hidden layer may be referred to as an input value based on the second hidden layer, and may be referred to as an intermediate value based on the NN model 200.

Hereinafter, an integer format, a fixed point format, or a floating point format for representing input values and weights will be described.

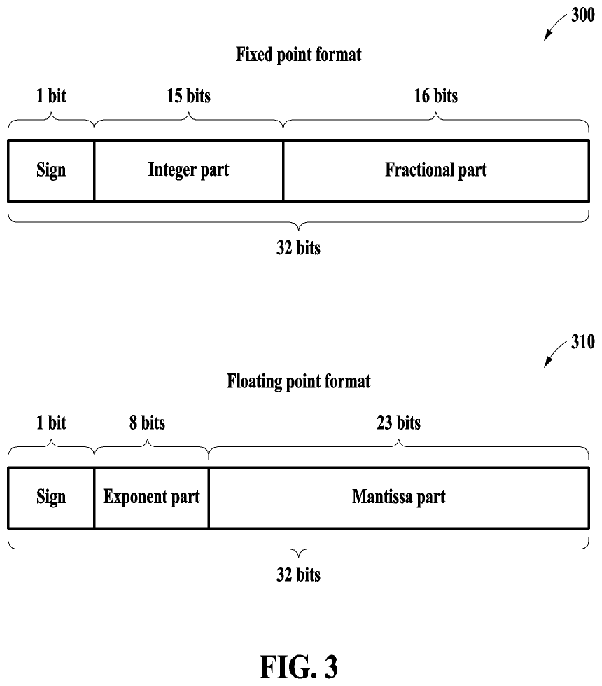

FIG. 3 illustrates an example of representation formats of real numbers, according to one or more embodiments.

Referring to FIG. 3, a fixed point format 300 and a floating point format 310 are illustrated as representation formats of real numbers. Also, there may be an integer format as the representation format of a real number.

The integer format may be a format that removes a decimal point of a real number and expresses only an integer part thereof. The integer format may include a 1-bit sign part and the integer part. For example, the integer format may be represented as INT8, INT16, INT32, or the like. INT8 is an 8-bit integer representation, which may include a 1-bit sign part and a 7-bit integer part. INT16 may be a 16-bit representation of an integer. INT32 may be a 32-bit representation of an integer. For example, when 10 is represented in the integer format (e.g., INT8), it may be represented as “00001010.” For example, when 10 is represented in the integer format (e.g., INT16), it may be represented as “0000000000001010.”

The fixed point format 300 may be a format that may fix the position of a decimal point and represent a decimal with fixed decimal places. The fixed point format 300 may represent a decimal point. The fixed point format 300 may include a sign part, an integer part, and a fractional part. For example, a 32-bit fixed point format 300 may include a 1-bit sign part, a 15-bit integer part, and a 16-bit fractional part. For example, when representing 21.25 in the fixed point format 300, the sign part may be represented as “0,” the integer part may be represented as “000000000010101,” and the fractional part may be represented as “0100000000000000.”

The floating point format 310 may be a format that represents a real number without fixing the position of a decimal point. The floating point format 310 may include a sign part, an exponent part, and a mantissa part (as used herein “mantissa” refers to a significand). The floating point format 310 may be predetermined in a normalized form according to the IEEE 754 standard. For example, FP32 may be predetermined to include a 1-bit sign part, an 8-bit exponent part, and a 23-bit mantissa part. For example, FP16 may be predetermined to include a 1-bit sign part, a 5-bit exponent part, and a 10-bit mantissa part. For example, BF16 may be predetermined to include a 1-bit sign part, an 8-bit exponent part, and a 7-bit mantissa part. For example, when representing 21.25 in the floating point format 310 (e.g., FP32), the sign part may be represented as “0,” the exponent part may be represented as “10000011,” and the mantissa part may be represented as “01010100000000000000000.”

A bit width may refer to a total number of bits used to represent data. For example, for INT8, the bit width may be 8, and for FP32, the bit width may be 32.

Bit precision may be proportional to a bit width. This is because as the bit width increases, the range of real numbers that may be represented is widened. For example, increasing the bit width may widen the representable range of real numbers and increase the bit precision. For example, decreasing the bit width may narrow the representable range of real numbers and decrease the bit precision.

Meanwhile, increasing the bit width may achieve a wider range and higher bit precision, however, it may use more memory resources and make calculations more complex. For example, the bit width and the bit precision may be in a trade-off relationship with memory resources and complexity of calculations. Therefore, if necessary, it may be necessary to control the bit precision by reducing the bit width.

Hereinafter, a method of maintaining inference accuracy while controlling bit precision by compressing weights and/or input values will be described.

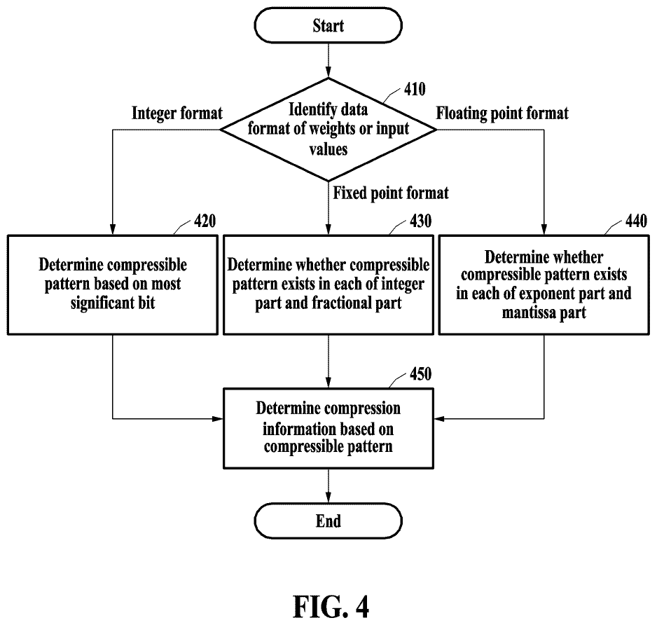

FIG. 4 illustrates an example of an operation of an electronic device for determining compression information, according to one or more embodiments.

Operations illustrated in FIG. 4 may be performed by at least one component of the electronic device. For example, when instructions included in a memory are executed individually and/or collectively by at least one processor, the electronic device may perform the following operations. The at least one processor may include at least one of a host processor or an accelerator. For example, the following operations may be performed by a compression information determination module/algorithm included in the accelerator or the host processor.

In operation 410, the electronic device may identify a data format of weights or input values.

Input data may be input to a NN model that includes layers. The NN model may perform inference based on the input data. The NN model may perform inference through sequential operations of the layers. The electronic device may identify the data format of weights and input values of a target layer, the target layer being a layer among the layers of the NN in which an operation is to be performed. The weights of the target layer may be determined through training of the NN model. The input values of the target layer may be output values of a layer immediately preceding the target layer. The following description of FIG. 4 references these weights and inputs.

For example, the electronic device may determine that the data format of the weights of the target layer is FP32, i.e., a particular floating point format. For example, the electronic device may determine that the data format of the input values of the target layer is BF16, i.e., another particular floating point format. However, this is merely an example and the present disclosure is not limited thereto.

When the weights are determined to be in an integer format, the electronic device may perform operation 420 thereon. When the input values are determined to be in an integer format, the electronic device may perform operation 420 thereon. When the weights are determined to be in a fixed point format, the electronic device may perform operation 430 thereon. When the input values are determined to be in a fixed point format, the electronic device may perform operation 430 thereon. When the weights are determined to be in a floating point format, the electronic device may perform operation 440 thereon. When the input values are determined to be in a floating point format, the electronic device may perform operation 440. For example, when the weights are determined to be in a floating point format and the input values are determined to be in an integer format, the electronic device may perform operation 440 on the weights and perform operation 420 on the input values. Operations 420, 430, and 440 may be performed on each individual weight or input value, thus obtaining pieces of compression information for the respective weights (or indications of lacking the same, in such cases) and pieces of compression information for the respective input values (or indications of lacking the same, in such cases). Each piece of compression information may include an indication of the corresponding compressible pattern (e.g., a “0”s prefix or postfix), among other possible information to be used for compression. An indication of a prefix or postfix might be an index of a bit position or length, a mask, or the like.

In operation 420, the electronic device determines/identifies a compressible pattern (a pattern or run of bits that can be compressed) of a weight, and may do so based on a most significant bit thereof (e.g., based on a data property of a portion of the weight/input that includes the most significant thereof).

Specifically, when the weights are in an integer format, the electronic device may determine the compressible pattern of a weight based on the bit position of the most significant “1” bit of that weight. When weights in the integer format have respective prefixes of one or more consecutive 0's based on the most significant bits of the weights (i.e., the weights start, from the most significant end, with a run 1 or more consecutive “0”s), the electronic device may determine the prefixes of these weights to be the compressible patterns of the weights in the integer format. Weights lacking a compressible pattern may be not compressed. Regarding the weights that are not compressed, some weights that can be compressed will be compressed, while other weights that cannot be compressed will remain uncompressed. Since operations are performed between weights and inputs, it is not problematic even if the weights have different data formats. Operations are still possible when the data formats of the corresponding between the weights and inputs differ (due to some being compressed and some not being compressed). Intermediate conversions—such as matching data formats or aligning the number of bits—may be performed. Additionally, if an operator that supports operations between mixed data formats (as described below) exists, operations can be performed directly without any intermediate conversion.

The electronic device may determine/identify the compressible patterns of the respective weights by bit-scanning the weights in the integer format, starting from the most significant bit. A bit scan on a weight may be performed by ANDing a single “1” bit with the bits of the weight, starting with the most significant bit thereof (e.g., left to right). The first bit position of the weight at which the ANDing results in a true/“1” is the bit position of the most significant “1” bit in the weight. If the most significant “1” bit of the weight is not the most significant bit of the weight (i.e., there is a prefix of one or more consecutive “0”s starting at (or based on) the most significant bit of the weight), then, the electronic device may determine that a compressible pattern exists in the weights, and the extent of the compressible pattern is now known.

For example, the weight may be in the integer format, “0011011” (the sign part is omitted). The electronic device may perform a bit scan starting from the most significant bit. In “0011011,” the most significant bit (the leftmost/first bit)is “0”. The AND operation is performed starting from the most significant bit using the single bit “1.” The electronic device may determine that the weight is in use starting from the bit position where the first “1” (from the most significant bit position) is found. The electronic device may determine that the first bit position (from most significant bit direction) storing weight data is the third bit position based on “00011011.” Since the bit position of the most significant bit of weight data is not the most significant bit of the floating point format (i.e., there is at least one “0” prefixing the most significant end of the weight), the electronic device may determine that a compressible pattern exists in the weight. In brief, any prefix of one or more consecutive “0”s of a weight may be interpreted as a compressible pattern of that weight.

The method described above of determining the compressible pattern for a weight may also be applied to a case where an input value is in an integer format. In addition, various operations such as OR operation, XOR operation, and the like may be used instead of the AND operation, in order to determine the compressible pattern, and a single bit “0” may be used instead of a single bit “1”, as the case may be.

In operation 430, the electronic device may determine whether a compressible pattern exists in the integer part of the fixed point weight and whether a compressible pattern exists in the fractional part of the fixed point weight.

The electronic device may determine a compressible pattern for each integer part and its corresponding fractional part when the weight is determined to be in a fixed point format. When the integer part of the weight has one or more consecutive “0”s as a prefix at its most significant end (i.e., based on the integer part's most significant bit), the electronic device may determine this prefix as the compressible pattern of the integer part. When the fractional part of the weight has one or more consecutive “0” bits as a postfix at its least significant end (e.g., based on its least significant bit), the electronic device may determine this postfix as the compressible pattern of the fractional part.

The electronic device may determine the compressible pattern by bit-scanning each of the integer part and the fractional part. The same technique described above with reference to operation 420 may be used, but with reverse order (bit scanning from the least significant bit of the weight) for the fractional part of the fixed point weight. When the integer part of the weight has a prefix at its most significant end of 1 or more “0”s, then the electronic device may determine that a compressible pattern exists in the integer part (and determine its length/extent); the compressible pattern being the “0”s prefix.

For example, when the integer part is “00011011,” the electronic device may perform a bit scan starting from the most significant bit position of the weight's fixed point format using a single bit “1” to test the weight's bits. In “00011011,” the most significant bit (the leftmost/first bit) is “0,”. The electronic device may perform the AND operation starting from the most significant bit using the single bit “1.” The electronic device may determine that the integer part is in use (has data) starting from the bit position where the first “1” is detected by performing the bit scan starting from the least significant bit/end of the weight. In this example, the electronic device determines that the integer part is in use starting from the fourth bit position. Since the bit position where the integer part is determined to be in use is not the most significant bit position possible (e.g., leftmost bit), the electronic device may determine that a compressible pattern exists in the integer part (and determine its extent/length).

The electronic device may perform a bit scan on the fractional part by applying a single bit “1”, in the same manner as described above, but starting from the last significant bit position of the corresponding fixed point format to determine if there is a “0”s postfix at the fractional part's least significant end (e.g., a “0”s postfix including the least significant bit). When the bit position where the fractional part is determined to first store weight data (i.e., the first position that has a “1” from the least significant direction) is not the least significant bit position of the weight's fixed point format, the electronic device may determine that a compressible pattern exists in the fractional part (and determine its extent/position).

For example, when the fractional part is “01110000,” the electronic device may perform a bit scan starting from the least significant bit using the single bit “1.” In “01110000,” the least significant bit (the rightmost bit) is “0”. When the electronic device performs the AND operation starting from the least significant bit using the single bit “1”, it may determine that the fractional part is in use (has data) starting from the bit position, where the first “1” is found by the bit-scanning starting from the least significant bit position. The electronic device may determine that the fractional part is in use (has data) starting at the fifth bit. Since the bit position where the fractional part is determined to be in use is not the least significant bit, the electronic device may determine that a compressible pattern exists in the fractional part.

The other methods of determining the compressible pattern described above may also apply to the case where the input value is in a fixed point format.

In operation 440, the electronic device may determine whether a compressible pattern exists in the exponent part and the mantissa part of the corresponding floating point format weight.

When the exponent part of the weight is determined to be within a compressible range, as described below, the electronic device may determine that the exponent part has a compressible pattern. When the mantissa part of the weight may be approximated to a specific value, the electronic device may determine that the mantissa part has a compressible pattern. Specifically, when (a) the number (e.g., X) of consecutive 0's postfixing the mantissa part of the weight (from the least significant bit) is (b) greater than or equal to (c) a value obtained by subtracting (c-i) the number (e.g., N) of bits in the exponent part that are in a corresponding target compressed format from (c-ii) the number (e.g., M) of bits in the exponent part in a current format of the weight (i.e., the size of the exponent, not the number of bits used by any particular exponent value), the electronic device may determine that the mantissa part has a compressible pattern. For example, the electronic device may determine that the mantissa has a compressible pattern when X>=M−N (M−N corresponds to the number of bits of actual data of an exponent value within the exponent space, i.e., non-prefix data).

As an example, assume that the number of consecutive 0's postfixing the mantissa part from the least significant bit/end thereof (e.g., “10101011000000000000000”) of the weight (e.g., FP32) is 15 (i.e., X=15), and the number of bits in the exponent part in a corresponding target compressed format (e.g., FP16) is 10 bits (e.g., N=10) in the number of bits in the exponent part in the current format of the weight, which is 23 (i.e., M=23). Since M−N is 13 and X is greater than or equal to 13, it may be determined that the mantissa part has the compressible pattern.

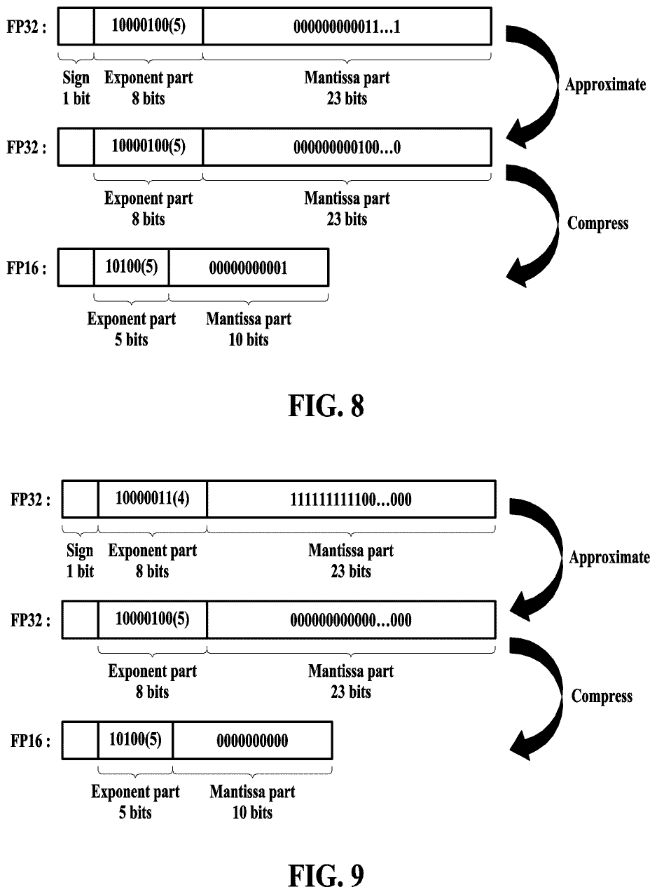

Examples of compressible patterns are further described with reference to FIGS. 8 and 9.

When the exponent part of the input value is within a compressible range, the electronic device may determine that the exponent part has a compressible pattern. When the mantissa part of the input value may be approximated to a specific value, the electronic device may determine that the mantissa part has a compressible pattern. The determining whether the mantissa part of the input value has the compressible pattern is the same as the determination for the weight.

For the floating point format, the number of bits in the exponent part may be normalized and predetermined according to the IEEE 754 standard. For example, in FP32, the exponent part may be predetermined to have 8 bits. In FP16, the exponent part may be predetermined to have 5 bits. In BF16, the exponent part may be predetermined to have 8 bits. In FP8, the exponent part may be predetermined to have 5 bits (5M2E) or 4 bits (4M3E).

With floating point format, when an actual value of an exponent in an exponent part of a weight/input of the current format is within a range of the actual values of the exponent that are able to be represented by a corresponding exponent part in a target compressed format, it may be determined that the exponent part is within the compressible range. The range of actual values of the exponent that may be represented by FP 12 may be −126 to 127. The range of actual values of the exponent that may be represented by FP16 may be −14 to 15. The range of actual values of the exponent that may be represented by BF 16 may be −126 to 127. The range of actual values of the exponent that may be represented by FP8 (5M2E) may be −14 to 15. The range of actual values of the exponent that may be represented by FP8 (4M3E) may be −6 to 7.

For example, when the exponent of an input/weight in FP32 format is “10000100” (i.e., decimal 132), the bias of FP 32 is 127, and therefore, the actual value of the exponent may be 5 (i.e., 132-127=5). Incidentally, regarding the bias of a floating point format, usually, the exponent part of a floating point number is stored as a positive integer with no sign bit. The bias of the corresponding floating point format is an integer subtracted from an exponent to map the exponent to its true value; the bias maps the exponent from a range of positive integers to a range of negative and positive integers. For example, the bias of 127 for FP32 maps a stored exponent's range from [1,254] to the actual range of [−126,127] by subtracting 127 from the exponent part. Since 5 is within the range of the actual values of the exponent that may be represented by FP16, BF16, FP8 (5M2E), and FP8 (4M3E), it may be determined that the exponent part has a pattern compressible to FP16, BF16, FP8 (5M2E), and FP8 (4M3E).

For example, when the exponent of FP is “10010000” (i.e., decimal 144), the bias of FP32 is 127, and therefore, the actual value of the exponent may be 17 (i.e., 144−127=17). Since 17 is within the range of the actual values of the exponent that may be represented by BF16, it may be determined that the exponent part has a pattern compressible to BP17.

The determining of whether the mantissa part has the compressible pattern will be further described with reference to FIGS. 8 and 9.

In operation 450, the electronic device may determine compression information based on the compressible pattern. The compression information may include information indicating that the weight is compressible to a specific format and information on a bit position of a compressible bit (within the relevant format/part of the weight/input). The electronic device may perform compression on the weight based on the compression information.

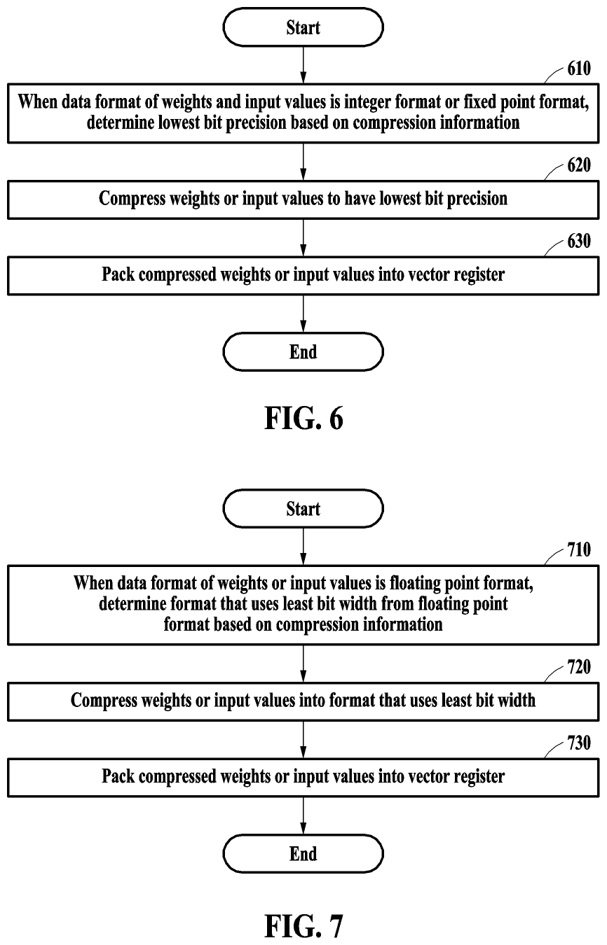

The electronic device may perform optimization for target hardware by packing the compressed weight according to the length of a vector register. The optimization for the target hardware will be further described with reference to FIGS. 6 and 7.

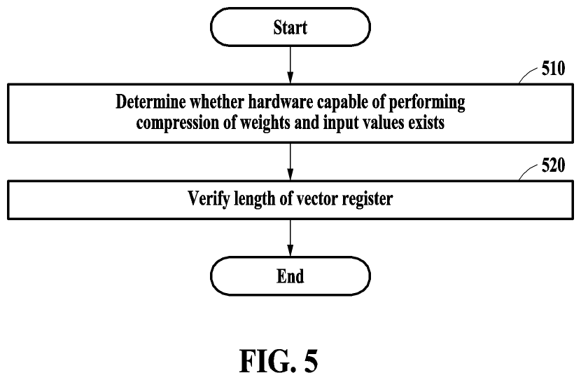

FIG. 5 illustrates an example of an operation of an electronic device for verifying the length of a vector register and presence of hardware performing compression, according to one or more embodiments.

Operations illustrated in FIG. 5 may be performed by at least one component of the electronic device. For example, when instructions included in a memory are executed individually and/or collectively by at least one processor, the electronic device may perform the following operations. The at least one processor may include at least one of a host processor or an accelerator. For example, the following operations may be performed by a hardware identification module as a hardware device included in the accelerator or the host processor.

In operation 510, the electronic device may determine whether hardware of the electronic device is capable of performing compression of weights and input values exists.

The electronic device may determine whether hardware (e.g., a compressor) capable of performing compression of the weights and/or input values exists within the electronic device. When there is hardware capable of performing compression of the weights and input values, the electronic device may identify a data format (e.g., a floating point format) supported by the hardware. When there is no hardware capable of performing compression of the weights and input values within the electronic device, the electronic device may compress weights and input values by instructions/code executed on a processor of the electronic device, for example a host processor or CPU.

According to an example, when determined that there exists hardware capable of performing compression of the weights and input values and the hardware supports (e.g., can operate on) the data format of the weights and the input values, the electronic device may compress the weights and the input values using the hardware. Even if hardware capable of performing compression of the weights and input values exists, if the hardware does not support the data format of the weights and the input values, the electronic device may compress the weights and the input values using instructions/code executed on the host processor/CPU.

In operation 520, the electronic device may verify the length of a vector register.

The verified length of the vector register may be used when packing the compressed weights and compressed input values.

Compression performed for weights and input values is described next.

FIGS. 6 and 7 illustrate examples of an operation of an electronic device for performing compression and packing, according to one or more embodiments.

FIG. 6 illustrates a method of performing compression and packing when weights or input values are in an integer format or a fixed point format.

Operations illustrated in FIG. 6 may be performed by at least one component of the electronic device. For example, when instructions included in a memory are executed individually and/or collectively by at least one processor, the electronic device may perform the following operations. The at least one processor may include at least one of a host processor or an accelerator. For example, the following operations may be performed by a compression and vectorization module as a hardware device included in the accelerator or the host processor.

In operation 610, when the data format of weights or input values of the target layer/operation is an integer format or a fixed point format, the electronic device may determine a lowest bit precision based on the compression information.

For example, assume that the data format of a weight, among the weights, is the integer format, “0011011” (the sign part is omitted). The compression information may include information indicating that compression may be performed up to a second bit relative to (or away from) the most significant bit position of the integer format. The electronic device may determine the lowest bit precision based on the compression information. The lowest bit precision may be a narrowest bit width (or bit length) among the weights. Based on the compression information, the lowest bit precision may be determined as a case where the bit width/length of the integer part is 5. Including the sign part, the lowest bit precision may be determined as a case where the bit width is 6. Regarding the phrase “determining the lowest bit”, this refers to selecting the data format with the fewest number of bits used to represent values among the compressible data formats. A lower bit precision indicates that fewer bits are used to express a value. For example, assume that weights are represented in the FP32 data format and can be compressed into FP16 and FP8 formats. In this case, determining the lowest bit precision may involve selecting FP8 as the data format, since it uses the fewest number of bits. The term “lowest bit precision” is equivalent to using the narrowest bit width. FP8 represents values using 8 bits, while FP16 uses 16 bits. Therefore, FP8 has the narrowest bit width.

For example, assume that the data format of the weight is a fixed point format, and the integer part is “00011011” and the fractional part is “01110000.” The previously computed compression information of the weight may include information indicating (i) that the integer part is compressible up to the third bit from the most significant bit of the integer part of the fixed point format and (ii) that the fractional part is compressible up to a fourth bit from the least significant bit of the fractional part of the fixed point format. The electronic device may determine the lowest bit precision based on the compression information. The lowest bit precision may refer to a narrowest bit width. Based on the compression information, the lowest bit precision may be determined as a case where the bit width of the integer part is 5 and the bit width of the fractional part is 4.

In operation 620, the electronic device may compress the weights (or the input) values to have the previously determined lowest bit precision among the weights (or the input).

The electronic device may perform compression by performing bit masking on the compressible pattern of the weights to have the lowest bit precision.

For example, when the data format of the weight is integer, the electronic device may compress the weight from “00011011” to a weight with the lowest bit precision, which would be “11011”; the bit width of the compressed weight is 5.

For example, when the data format of the weight is a fixed point format, in which the integer part is “00011011” and the fractional part is “01110000,” the electronic device may compress the integer part to “11011” and the mantissa part to “0111”; the bit width of the compressed weight is 10, including the sign part.

In operation 630, the electronic device may pack the compressed weights or input values into a vector register.

The electronic device may pack the compressed weights or input values into the vector register based on a length of the vector register. The electronic device may perform vectorization by packing the compressed weights or input values into the vector register.

The electronic device may perform optimization for the target hardware. For example, the electronic device may perform optimization for the vector register by packing compressed weights or input values based on the length of the vector register. For example, when the format of the weights is FP32 (e.g., 32 bits) and the length of the vector register is 64 bits, two weights may be packed into the vector register. When the weights are compressed, the electronic device may pack as many compressed weights or compressed input values into the vector register as possible without exceeding the length of the vector register. For example, when the length of the vector register is 64 bits and the bit width of the compressed weight is 8, eight compressed weights (or input values) may be packed into the vector register. For example, when the length of the vector register is 64 bits and the bit width of the compressed weight is 16, four compressed weights may be packed into the vector register. Through the compression, more compressed weights or compressed input values are packed into the vector register with the same length, thereby optimizing utilization of the target hardware.

The compressed weights and compressed input values may be packed into the vector register and operated upon in parallel from the vector register.

Operations 610 to 630 described above may be applied when the input value is in an integer format or a fixed point format.

FIG. 7 illustrates a method of performing compression and packing when weights or input values are in a floating point format.

Operations illustrated in FIG. 7 may be performed by at least one component of the electronic device. For example, when instructions included in a memory are executed individually and/or collectively by at least one processor, the electronic device may perform the following operations. The at least one processor may include at least one of a host processor or an accelerator. For example, the following operations may be performed by a compression and vectorization module as a hardware device and/or code included in the accelerator or the host processor.

In operation 710, when the data format of weights or input values is a floating point format, the electronic device may determine a format that provides the smallest possible bit width, among the weights or input values, for the floating point format thereof, and may do so based on the compression information.

For example, assume that the data format of the weights is the floating point format FP32, the exponent part of a weight is, for example, “00001010” (8 bits) and the mantissa part of the weight is, for example, “11110000000000000000000” (23 bits). Pieces of compression information for the respective weights may include information indicating that the weights (including the example weight) are compressible to 16 bits (e.g., FP16 and BF 16) and 8 bits (e.g., FP8). A method of determining the compression information in the floating point format is described below with reference to FIGS. 8 and 9. A format that uses the least bit width for the weights may corresponds to a lowest possible precision. For example, based on the pieces of compression information, the bit width may be determined to be 8 bits, which is the least bit width among the weights (or input values).

In operation 720, the electronic device may compress the weights or input values into the format that uses the least bit width.

The electronic device may perform bit masking and bit shifting on the compressible patterns of the weights to compress the weights into the format that uses the least bit width. For example, the electronic device may select only weight bit data to be used through the bit masking, and move the bits to appropriate positions (e.g., in a vector register or cache/memory feeding the vector register) through the bit shifting.

For example, based on the data format of the weights being the floating point format FP32, for example, and the compression information indicating that the weights are compressible to BF16, the electronic device may compress a weight with exponent part “00001010” and mantissa part “10100000000000000000000” into the exponent part of “00001010” and the mantissa part of “1010000” through the bit masking. At this time, compression to FP16 and FP8 is not possible, and thus, the format that uses the least bit width may be selected to be BF16.

For example, based on the data format of the weight being the floating point format FP32 and the compression information indicating that the weight is compressible to FP16, the electronic device may compress the weight with exponent part “10000011” and mantissa part “11110000000000000000000” into an exponent part of “10100” and a mantissa part of “0000000000” through the bit masking and/or the bit shifting. The case where the mantissa part has consecutive 1's based on the most significant bit is further described with reference to FIG. 9. At this time, compression to FP8 is not possible, and thus, FP16 and BF16 may be determined as the formats that can use the previously determined least bit width of the weights (or input values).

In operation 730, the electronic device may pack the compressed weights or input values into a vector register.

The electronic device may pack the compressed weights or input values into the vector register based on the length/size of the vector register. The electronic device may perform vectorization by packing the compressed weights or input values into the vector register.

The electronic device may perform optimization for the target hardware. For example, the electronic device may perform optimization for the vector register by packing the compressed weights or input values based on the length of the vector register. For example, when the format of the weights is FP 32 and the length of the vector register is 64 bits, two uncompressed weights may be packed into the vector register. When the weights are compressed, the electronic device may pack as many of the compressed weights or input values into the vector register as possible without exceeding the length of the vector register. For example, when the length of the vector register is 64 bits and the bit width of the compressed weight is 8 bits (e.g., FP8), eight compressed weights may be packed into the vector register. For example, when the length of the vector register is 64 bits and the bit width of the compressed weight is 16 (e.g., FP16), four compressed weights may be packed into the vector register. Through the compression, more compressed weights or compressed input values are packed into the vector register with the same length, thereby optimizing utilization of the target hardware.

The compressed weights and compressed input values may be packed into the vector register and operated upon in parallel.

In some implementations, the bit width of the compressed weights or the bit width of the compressed input values may be different from the bit width supported by the vector register. For example, the compressed weights or compressed input values may be in FP8 format, while the vector register supports only FP32 and FP16. For compatibility with the vector register, the electronic device may restore the compressed weights or compressed input values to a bit width supported by the vector register. For example, the electronic device may expand the compressed weights or the compressed input values in FP8 format to FP16 or FP32. The electronic device may restore the compressed weights or the compressed input values to a data format with a larger bit width when performing restoration. Bit shifting may be used during the restoration.

Operations 710 to 730 described above may may be applied in cases where the input values are in a floating point format.

The compressible pattern in the floating point format is described next.

FIGS. 8 and 9 illustrate examples of a compressible pattern in a floating point format, according to one or more embodiments.

Referring to FIG. 8, a weight or input value with a data format of FP32 is illustrated. FP32 generally includes a 1-bit sign part, an 8-bit exponent part, and a 23-bit mantissa part. In FIG. 8, the values in parentheses in the exponent parts represent an actual value of the exponent part (according to the bias). The actual value of the exponent part is obtained by subtracting the corresponding bias from the value representing the exponent part.

When the data format of the weights or input values is a floating point format, the electronic device may determine whether a compressible pattern exists in each of the exponent part and the mantissa part of the weights or input values.

The method of determining whether the compressible pattern exists in the exponent part is described above with reference to FIG. 4. For example, when the actual value of the exponent part is 5, the bias of FP 32 is 127, and therefore, the exponent part may be represented as “10000100” (decimal 132) in FP32. For example, the actual value of the exponent part represented in FP32, which is 5, is within the range of the actual value of the exponent that may be represented by the exponent part in FP16, and accordingly, it may be determined that the compressible pattern exists. For example, the exponent part of “10000100” represented in FP32 may be represented as “10100” in FP16. The bias of FP 16 is 15, and the actual value of the exponent part, 5, may be represented as “10100” (decimal 20) in the exponent part of FP16.

The electronic device may determine whether the mantissa part has a compressible pattern. When the mantissa part may be approximated to a specific value (see the following paragraphs), the electronic device may determine that a compressible pattern exists in the mantissa part.

When the mantissa part has one or more consecutive 1's from the least significant bit (e.g., a rightmost bit), the electronic device may determine that the mantissa part may be approximated to a specific value. When the mantissa part has one or more consecutive 1's from the least significant bit (e.g., from a rightmost bit), the electronic device may determine that the mantissa part has a compressible pattern.

For example, when it is assumed that the mantissa part is “000000000011 . . . 1” (23 bits), the mantissa part represents (1×2⁻¹¹)+(1×2⁻¹²)+(1×2⁻¹³)+(1×2⁻¹⁴) . . . +(1×2⁻²³), and the electronic device may determine that the mantissa part may be approximated to 1×2⁻¹⁰(e.g., “000 . . . 10000000000000” (23 bits)). The electronic device may raise an upper (more significant) bit to 1 and change the remaining bits to 0 through a carry operation. Thus, the electronic device may determine that the mantissa part of “000 . . . 01111111111111” (23 bits) has a compressible pattern (“000 . . . 01111111111111” is the same as the 23 bits in the first sentence of this paragraph, but here it is represented differently to indicate a compressible pattern).

When a compressible pattern exists in each of the exponent part and the mantissa part, the electronic device may determine whether each of the exponent part and the mantissa part may be compressed to satisfy a predetermined number of bits.

The predetermined number of bits may refer to the number of bits that is normalized and predetermined according to the IEEE 754 standard. For example, FP 32 may be predefined to include a 1-bit sign part, an 8-bit exponent part, and a 23-bit mantissa part based on the IEEE 754 standard. For example, FP 16 may be predefined to include a 1-bit sign part, a 5-bit exponent part, and a 10-bit mantissa part based on the IEEE 754 standard.

Determining whether the exponent part is within the compressible range may be based on the predefined number of bits. Accordingly, when it is determined that the exponent part has a compressible pattern, it may imply that the exponent part may be compressed to satisfy the predefined number of bits.

The electronic device may determine whether the approximated mantissa part may be compressed to satisfy the predefined number of bits based on the approximated mantissa part. The approximated mantissa part may have consecutive 0's at its least bit/end. When the number (e.g., X) of consecutive 0's at the least significant bit/end in the approximated mantissa part of the weight is greater than or equal to a value obtained by subtracting the number (e.g., N) of bits in the exponent part in a corresponding target compressed format from the number (e.g., M) of bits in the approximated exponent part in a current format of the weight, the electronic device may determine that the mantissa part has a compressible pattern. For example, the electronic device may determine that the mantissa has a compressible pattern when X>=M−N.

For example, assume that the number of consecutive 0's at the least significant bit/end of the approximated mantissa part (e.g., “00000000010 . . . 0”) of the weight (e.g., FP32) is 13 (i.e., X=13), and the number of bits in the exponent part in a corresponding target compressed format (e.g., FP16) is 10 bits (e.g., N=10) in the number of bits in the exponent part in the current format of the weight, which is 23 (i.e., M=23). Since M−N is 13 and X is greater than or equal to 13, it is determined that the approximated mantissa part has a compressible pattern.

The compression described directly above is an example and the present disclosure is not limited thereto.

When each of the exponent part and the mantissa part may be compressed to satisfy the predetermined number of bits, the electronic device may determine the piece of compression information corresponding to the weight/input based on the compressible pattern.

When each of the exponent part and the mantissa part has a compressible pattern and may be compressed to have (together) a predetermined bit width, the electronic device may determine the compression information. The electronic device may perform the operations of FIG. 7 based on the piece of compression information.

FIG. 9 illustrates a weight or input value with a data format of FP32. FP32 may include a 1-bit sign part, an 8-bit exponent part, and a 23-bit mantissa part. In FIG. 9, for convenience of description, only the exponent part and the mantissa part are illustrated. In FIG. 9, a value in parentheses in the exponent part indicates the actual value of the exponent part (i.e., the value of the exponent part obtained by subtracting the corresponding bias from the value in the exponent part).

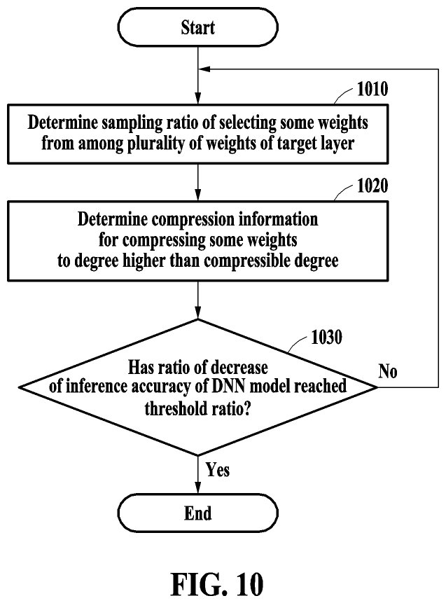

When the data format of the weights or input values is a floating point format, the electronic device may determine whether a compressible pattern exists in each of the exponent part and the mantissa part of the weights or input values. There may be cases where compression may occur even though the exponent or the mantissa might not have a compressible pattern. In this case, the operation of FIG. 10 may be utilized. That is, compression may be performed on at least one of the weights that do not have a compressible pattern. By compressing at least one of the weights that do not have the compressible pattern, some data loss may occur, and the inference accuracy of the neural network (NN) may be reduced. In this case, the number of weights to be compressed among the weights without compressible patterns and/or the degree of compression may be determined when a ratio of the decrease in the inference accuracy reaches a threshold. The degree of compression may refer to, for example, whether to compress from 32 bits to 16 bits or to 8 bits.

The electronic device may determine whether the mantissa part has a compressible pattern. When the mantissa part may be approximated to a specific value, the electronic device may determine that a compressible pattern exists in the mantissa part.

When the mantissa part has N or more consecutive 1's at its most significant end/bit (e.g., leftmost), the electronic device may determine that the mantissa part may be approximated to a specific value (e.g., 1). When the mantissa part has N or more consecutive 1's based on the most significant bit, the electronic device may determine that the mantissa part has a compressible pattern. N may be a natural number.

For example, when it is assumed that the mantissa part is “11111111110 . . . 000” (23 bits), the mantissa part may represent (1×2⁻¹)+(1×2⁻²)+(1×2⁻³) . . . +(1×2⁻¹⁰), and the electronic device may determine that the mantissa part may be approximated to the integer of 1. Since the mantissa part is approximated to the integer of 1, the mantissa part may be “0000000 . . . 000” (23 bits). The electronic device may determine whether the mantissa part of “1111000 . . . 000” (23 bits) has a compressible pattern.

Since the mantissa part is approximated to the integer of 1 (1×2⁰), the exponent part may be increased by 1. For example, when the exponent part is “10000011,” the exponent part may be increased by 1 and become “10000100.” In FP32, the exponent part of “10000100” represents the actual value of the exponent part, 5, and thus, the exponent part may have a compressible pattern that may be compressed into FP16. The electronic device may compress the exponent part of “10000100” in FP32 to the exponent part of “10100” in FP16.

When a compressible pattern exists in each of the exponent part and the mantissa part, the electronic device may determine whether each of the exponent part and the mantissa part may be sufficiently compressed to satisfy a predefined number of bits.

The predefined number of bits may refer to the number of bits that is normalized and predefined according to the IEEE 754 standard. For example, FP32 may be predefined to include a 1-bit sign part, an 8-bit exponent part, and a 23-bit mantissa part based on the IEEE 754 standard. For example, FP16 may be predefined to include a 1-bit sign part, a 5-bit exponent part, and a 10-bit mantissa part based on the IEEE 754 standard.

Whether the exponent part is within the compressible range may be determined based on the predefined number of bits. Accordingly, when it is determined that the exponent part has a compressible pattern, it may imply that the exponent part may be compressed to satisfy the predefined number of bits.

Since the mantissa part is approximated to the integer of 1, the mantissa part becomes “0000000 . . . 000” (23 bits), and thus, the mantissa part may be compressed to satisfy the predefined number of bits.

The compression described immediately above is an example and this disclosure is not limited thereto. For example, it is possible to determine whether FP32 may also be compressed into BF16 by the same method described above.

When each of the exponent part and the mantissa part may be compressed to satisfy the predefined number of bits, the electronic device may determine the compression information based on the compressible pattern.

When each of the exponent part and the mantissa part has a compressible pattern and may be compressed to have a predefined bit width, the electronic device may determine the compression information. The electronic device may perform the operations of FIG. 7 based on the compression information.

FIG. 10 illustrates an example of a method of increasing a degree of compression, according to one or more embodiments.

Operations illustrated in FIG. 10 may be performed by at least one component of the electronic device. For example, when instructions included in a memory are executed individually and/or collectively by at least one processor, the electronic device may perform the following operations. The at least one processor may include at least one of a host processor or an accelerator. For example, the following operations may be performed by a compression and vectorization module as a hardware device included in the accelerator or the host processor.

The performance of a NN model may be accelerated when compressing a weight to a degree higher than a compressible degree. When a weight is compressed to a degree higher than a compressible degree, the bit accuracy may decrease and the inference accuracy of the NN model may be less than that of the method described above with reference to FIGS. 1 to 9. Described next is a method of maintaining a decrease in the inference accuracy of the NN model at a threshold ratio while compressing the weight to a degree higher than a compressible degree.

In operation 1010, the electronic device may determine a sampling ratio for selecting some weights from among the weights of a target layer.

In operation 1020, the electronic device may determine compression information for some weights to be compressed to a degree higher than a compressible degree of the some other weights.

The electronic device may compress not only unused bits but also bits in use. The electronic device may perform approximation to perform compression even on the bits in use.

For example, assume that the mantissa is “000 . . . 00000111111111” (23 bits) according to FP32. The electronic device may approximate the mantissa part to “00000000010000000000000” (23 bits) instead of “00000000000001000000000” (23 bits) to be compressed into “0000000001” so as to satisfy 10 bits (which is the predefined bit width in target compressed format FP16). That is, the electronic device may perform the compression through the approximation even though a 14th bit based on the most significant bit (e.g., the rightmost bit) of the mantissa part is in use.

In operation 1030, the electronic device may determine whether a ratio of the decrease in the inference accuracy of the NN model reaches the threshold ratio.

The inference result of the NN model according to operations 1010 and 1020 may show a ratio that is decreased compared to an inference result of the NN model in which the compression is not performed on input values and weights. The threshold ratio may be determined by a user (and may act as a sort of accuracy control variable for the NN model).

When the ratio of the decrease in the inference accuracy has not reached the threshold ratio, the electronic device may perform operations 1010 and 1020 again. When the ratio of the decrease in the inference accuracy has reached the threshold ratio, the electronic device may terminate the operation of FIG. 10.

The electronic device may repeat operations 1010 and 1020, and determine an optimal sampling ratio and optimal compression information for the ratio of the decrease in the inference accuracy of the NN model to reach the threshold ratio.

The electronic device may accelerate the inference by effectively decreasing the bit width of the weight at the expense of sacrificing some accuracy of inference by a threshold ratio set by the user according to operations 1010 to 1030.

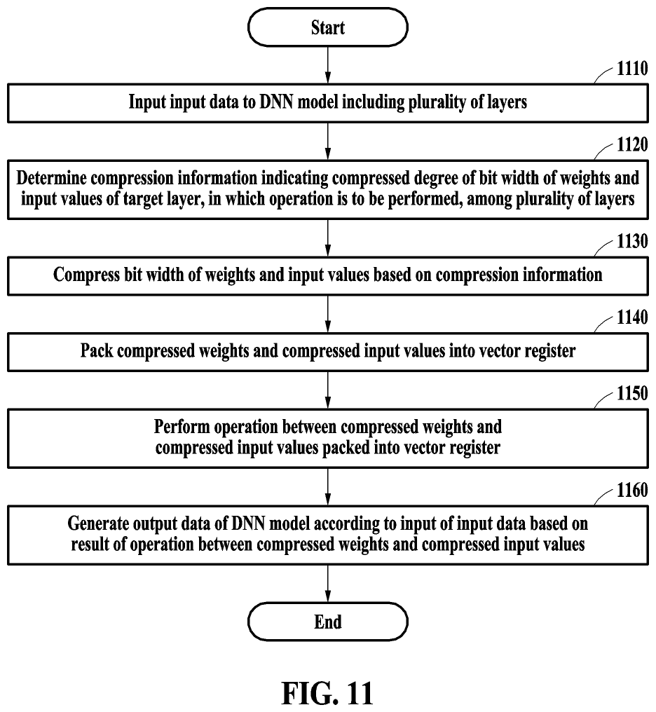

FIG. 11 illustrates an example of an operation of an electronic device, according to one or more embodiments.

Operations illustrated in FIG. 11 may be performed by at least one component of the electronic device. For example, when instructions included in a memory are executed individually and/or collectively by at least one processor, the electronic device may perform the following operations. The at least one processor may include at least one of a host processor or an accelerator.

In operation 1110, the electronic device may input input data to a NN model including layers.

In operation 1120, the electronic device may determine compression information indicating a compressed degree of a bit width of weights and input values of a target layer, in which an operation is to be performed, among the layers.

In operation 1130, the electronic device may compress the bit width of the weights and the input values based on the compression information.

In operation 1140, the electronic device may pack the compressed weights and the compressed input values into a vector register.

In operation 1150, the electronic device may perform an operation between the compressed weights and the compressed input values packed into the vector register.

According to an example, the electronic device may include an operator that supports operations between mixed data formats. The operator that supports operations between mixed data formats may perform operations between input values and weights having different data formats. When there is an operator that supports operations between mixed data formats, it is not necessary to perform preprocessing such as type casting to unify the data formats of input values and weights with different precisions, and accordingly, it may be possible to further accelerate the operation of the NN model.

In operation 1160, the electronic device may generate output data of the NN model according to an input of the input data based on a result of the operation between the compressed weights and the compressed input values.

Operations 1110 to 1160 are described above in greater detail with reference to FIGS. 1 to 10.

Operations 1120 to 1150 may be sequentially performed for all of the layers until the inference of the NN model is completed. For example, operations 1120 to 1150 may be sequentially performed from the first layer to the last layer of the NN model. Therefore, in the NN model, the bit width of the input value and weight may be dynamically adjusted for each layer to minimize the loss of inference accuracy of the NN model.

In addition, by controlling the bit precision and performing vectorization in different ways by considering the differences between the integer format, the fixed point format, and the floating point format, it may be possible to perform operations with less overhead than that in the related art, and accelerate the inference of the NN model without reducing the inference accuracy of the NN model.

Also, it may be possible to optimize the NN model by actively using hardware based on hardware support information and the length of a vector register.

The computing apparatuses, the electronic devices, the processors, the memories, the information output system and hardware, the storage devices, and other apparatuses, devices, units, modules, and components described herein, including descriptions with respect to respect to FIGS. 1-11, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-11 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A method of operating an electronic device, the method comprising:
inputting input data to a neural network (NN) model comprising layers;
determining compression information indicating a compressed degree of a bit width of weights and input values of a target layer, wherein the target layer is a layer among the layers in which an operation is to be performed;
compressing the weights and the input values to the bit width based on the compression information;
packing the compressed weights and the compressed input values into a vector register;
performing an operation between the compressed weights and the compressed input values packed into the vector register; and
generating output data of the NN model according to an input of the input data based on a result of the operation between the compressed weights and the compressed input values.

2. The method of claim 1, wherein the determining of the compression information comprises determining the compression information by identifying a data format of the weights and the input values and determining whether the weights and the input values are compressible by a method based on the data format.

3. The method of claim 1, wherein the determining of the compression information comprises:
in response to a data format of the weights or the input values being determined to be an integer format, determining whether a compressible pattern exists at the most significant bit of the weights or the input values; and
in response to the compressible pattern existing, determining the compression information based on the compressible pattern.

4. The method of claim 1, wherein the determining of the compression information comprises:
in response to a data format of the weights or the input values being determined to be a fixed point format, determining whether a compressible pattern exists for each of an integer part and a fractional part of the weights or the input values; and
in response to the compressible pattern existing in at least one of the integer part or the fractional part, determining the compression information based on the compressible pattern existing in at least one of the integer part or the fractional part.

5. The method of claim 4, wherein the determining of whether the compressible pattern exists comprises determining whether the compressible pattern exists based on a most significant bit of the integer part, and determining whether the compressible pattern exists based on a least significant bit of the fractional part.

6. The method of claim 1, wherein the determining of the compression information comprises:
in response to a data format of the weights or the input values being determined to be a floating point format, determining whether the compressible pattern exists for each of an exponent part and a mantissa part of the weights or the input values;
in response to the compressible pattern existing in each of the exponent part and the mantissa part, determining whether each of the exponent part and the mantissa part is compressible enough to satisfy a predefined bit number; and
in response to each of the exponent part and the mantissa part being compressible enough to satisfy the predefined bit number, determining the compression information based on the compressible pattern.

7. The method of claim 1, wherein the compressing of the weights and the input values to the bit width comprises:
in response to a data format of the weights being determined to be an integer format or a fixed point format, determining a lowest bit precision based on the compression information, and compressing the weights to have the lowest bit precision.

8. The method of claim 1, wherein the compressing of the weights and the input values to the bit width comprises:
in response to a data format of the weights or the input values being determined to be a floating point format, determining a format that uses a least bit width from the floating point format based on the compression information, and compressing the weights or the input values into a format that uses the least bit width.

9. The method of claim 1, wherein the packing of the compressed weights and the compressed input values into the vector register comprises, in response to a bit width of the compressed weights or a bit width of the compressed input values being different from a bit width supported by the vector register, restoring the compressed weights or the compressed input values to the bit width supported by the vector register.

10. The method of claim 1, further comprising:
determining a ratio of sampling some weights of the weights of the target layer until a ratio of decreasing inference accuracy of the NN model reaches a threshold ratio; and
determining the compression information for compressing the some weights to a degree higher than a compressible degree until the ratio reaches the threshold ratio.

11. A non-transitory computer-readable storage medium storing one or more programs,
wherein the one or more programs comprise code that when executed cause operations of:
inputting input data to a neural network (NN) model comprising layers;
determining compression information indicating a compressed degree of a bit width of weights and input values of a target layer, wherein the target layer is a layer among the layers in which an operation is to be performed;
compressing the weights and the input values to a bit width based on the compression information;
packing the compressed weights and the compressed input values into a vector register;
performing an operation between the compressed weights and the compressed input values packed into the vector register; and
generating output data of the NN model according to an input of the input data based on a result of the operation between the compressed weights and the compressed input values.

12. An electronic device comprising:
one or more processors; and;
a memory storing instructions that when executed by the one or more processors cause the electronic device to:
input input data to a neural network (NN) model comprising layers;
determine compression information indicating a compressed degree of a bit width of weights and input values of a target layer, wherein the target layer is a layer among the layers in which an operation is to be performed;
compress the weights and the input values to the bit width based on the compression information;
pack the compressed weights and the compressed input values into a vector register;
perform an operation between the compressed weights and the compressed input values packed into the vector register; and
generate output data of the NN model according to an input of the input data based on a result of the operation between the compressed weights and the compressed input values.

13. The electronic device of claim 12, wherein the instructions, when executed by the one or more processors, cause the electronic device to determine the compression information by identifying a data format of the weights and the input values and determining whether the weights and the input values are compressible by a method based on the data format.

14. The electronic device of claim 12, wherein the instructions, when executed by the one or more processors, cause the electronic device to:
in response to a data format of the weights or the input values being determined to be an integer format, determine whether a compressible pattern exists based on a most significant bit of the weights or the input values; and
in response to the compressible pattern existing, determine the compression information based on the compressible pattern.

15. The electronic device of claim 12, wherein the instructions, when executed by the one or more processors, cause the electronic device to:
in response to a data format of the weights or the input values being determined to be a fixed point format, determine whether a compressible pattern exists for each of an integer part and a fractional part of the weights or the input values; and
in response to the compressible pattern existing in at least one of the integer part or the fractional part, determine the compression information based on the compressible pattern existing in at least one of the integer part or the fractional part.

16. The electronic device of claim 15, wherein the instructions, when executed by the one or more processors, cause the electronic device to determine whether the compressible pattern exists based on a most significant bit of the integer part, and determine whether the compressible pattern exists based on the least significant bit of the fractional part.

17. The electronic device of claim 12, wherein the instructions, when executed by the one or more processors, cause the electronic device to:
in response to a data format of the weights or the input values being determined to be a floating point format, determine whether the compressible pattern exists for each of an exponent part and a mantissa part of the weights or the input values;
in response to the compressible pattern existing in each of the exponent part and the mantissa part, determine whether each of the exponent part and the mantissa part is compressible enough to satisfy a predefined bit number; and
in response to each of the exponent part and the mantissa part being compressible enough to satisfy the predefined bit number, determine the compression information based on the compressible pattern.

18. The electronic device of claim 12, wherein the instructions, when executed by the one or more processors, cause the electronic device to:
in response to a data format of the weights being determined to be an integer format or a fixed point format, determine a lowest bit precision based on the compression information, and compress the weights to have the lowest bit precision.

19. The electronic device of claim 12, wherein the instructions, when executed by the one or more processors, cause the electronic device to:
in response to a data format of the weights or the input values being determined to be a floating point format, determine a format that uses a least bit width from the floating point format based on the compression information, and compress the weights or the input values into a format that uses the least bit width.

20. The electronic device of claim 12, wherein the instructions, when executed by the one or more processors, cause the electronic device to:
in response to a bit width of the compressed weights or a bit width of the compressed input values being different from a bit width supported by the vector register, restore the bit width of the compressed weights or the bit width of the compressed input values to the bit width supported by the vector register.
